(19) United States
(12) Patent Application Publication
(10) Pub. No.: US 2012/0166378 A1
(43) Pub. Date: Jun. 28, 2012

(54) FORWARD CHAINING AS AN ORCHESTRATION MECHANISM FOR ANALYTICS

(75) Inventors: Matthew David Valerio, Bothell, WA (US); Stuart M. Bowers, Redmond, WA (US); Thomas E. Jackson, Redmond, WA (US); Chris Demetrios Karkanias, Sammamish, WA (US); Allen L. Brown, JR., Bellevue, WA (US); Brian S. Aust, Redmond, WA (US)

(73) Assignee: Microsoft Corporation, Redmond, WA (US)

(21) Appl. No.: 12/979,380

(22) Filed: Dec. 28, 2010

(51) Int. Cl. G06N 5/04

(52) U.S. Cl. 706/47; 706/54

(57) ABSTRACT

A method and system of using a forward chaining application on a computing device to monitor a semantic storage system and invoke computations on scientific data according to declarative rules, while capturing operational provenance data stored alongside the scientific data where all data is stored in a semantic graph is disclosed and described. As the provenance data is stored with the data as nodes in the semantic graph, it will stay with the data and may be searched and queried using the same methods as searching the underlying data.

### BACKGROUND

Scientific data supplies critical material for analysis of a variety of scientific disciplines. From testing DNA sequences to determining the origin of the universe, scientific data provides the basis for testing theories and creating new theories. However, trusting the data and the conclusions that have been made can be challenging if the source of the data is not known and the data has been analyzed in various ways. Tracking the original source of data is very important.

In addition, it may not be necessary to perform a particular analysis (most likely a resource-intensive process) on certain data because it may have already been performed in the past. However, attempting to determine whether the analysis has been performed previously is not possible unless information about what analyses have been applied to the data is also stored with the data.

Capturing this information about where the data originated and what analyses have been applied is extremely useful for researchers, and is typically referred to as “provenance data”. Without such details, data obtained as a result of the analysis may not be trusted or the analysis may be repeated, possibly wasting resources (e.g. compute power, network bandwidth, or researchers' time). In addition, capturing the provenance data also opens up the possibility for automatic orchestration of analyses using the data.

### SUMMARY

A method of using a forward chaining application on a computing device to monitor a semantic storage system for scientifically related data and to store provenance data related to the scientific related data in the semantic storage system is disclosed. Electronic scientific related data is stored in a semantic graph. In the forward chaining application, new scientific data that has been added to the semantic graph may be detected. Provenance data may be created about the new electronic scientific data. The provenance data may include a start time of computer operations on the data, an end time of the computer operations on the data, the type of analysis and information about the previous analyses that have manipulated the scientific related data.

The provenance data may be stored alongside the electronic scientific data as one or more nodes in the semantic graph with labeled edges between the nodes. As the provenance data is stored with the data as a node in the semantic graph, it will stay with the data and may be searched and queried using the same methods as searching the underlying data.

As a result of the method/system/apparatus, additional functionality may be possible that was not possible in the past. By keeping the provenance data with the underlying input data and output data, the provenance data will not be lost and will be searchable/queryable. By keeping the provenance data with the input data (and output data) and allowing it to be query-able, efficiencies, error corrections and improvements will become possible. In particular, by having the provenance data alongside the data, the system has enough information about past invocation of analyses that some analyses may be automatically invoked (orchestrated) based on common usage patterns.

### DESCRIPTION OF THE DRAWINGS

FIG. 1 illustrates a sample computing device that may be physically configured according to computer executable instructions;

FIG. 2 illustrates steps that are taken and the physical devices;

FIG. 3 illustrates a semantic graph of input data, provenance data and output data; and

FIG. 4 illustrates a search of a semantic graph.

### SPECIFICATION

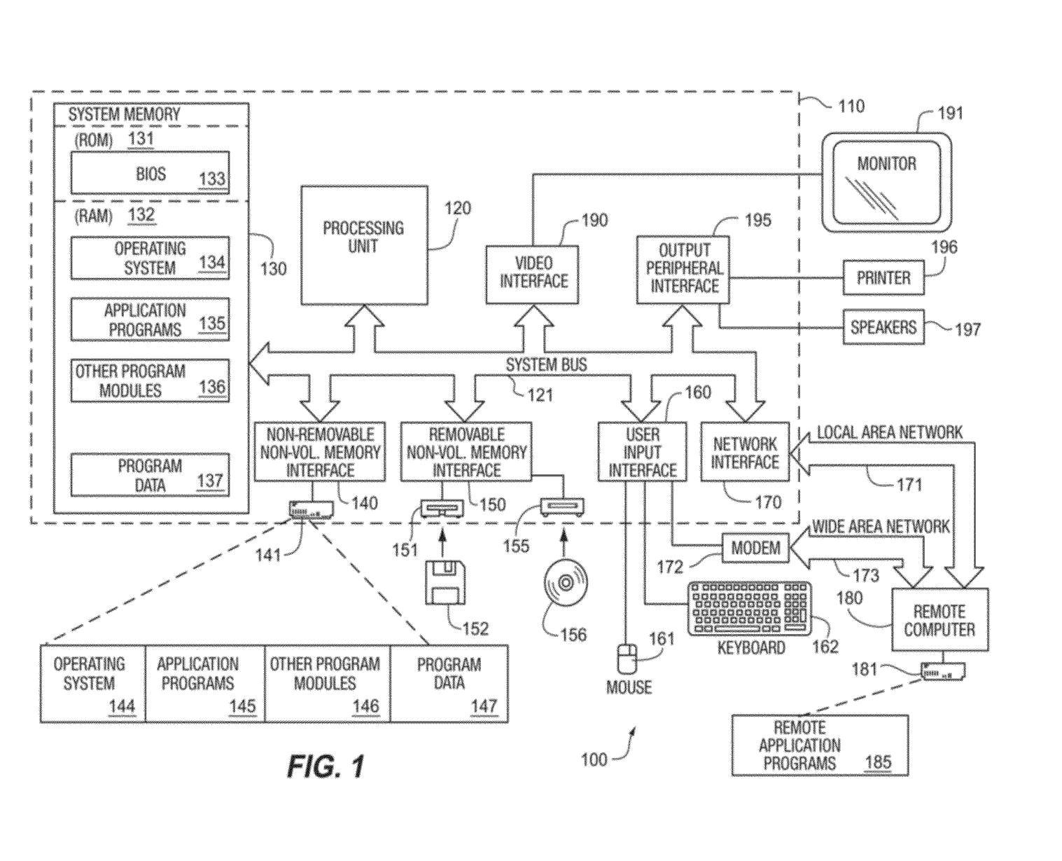

FIG. 1 illustrates an example of a suitable computing system environment 100 that may be physically configured to operate, display device and provide a user interface described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100. In one embodiment, the device described in the specification is entirely created out of hardware as a dedicated unit that is physically transformed according to the description of the specification and claims. In other embodiments, the device executes software and yet additional embodiment, the device is a combination of hardware that is physically transformed and software.

With reference to FIG. 1, an exemplary system that may be physically configured for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170. In addition, not all the physical components need to be located at the same place. In some embodiments, the processing unit 120 may be part of a cloud of processing units 120 or computers 110 that may be accessed through a network 171.

Computer 110 typically includes a variety of computer readable media that may be any available media that may be accessed by computer 110 and includes both volatile and nonvolatile media, removable and non-removable media. The system memory 130 may include computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150. However, none of the memory devices such as the computer storage media are intended to cover transitory signals or carrier waves.

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

In additional embodiments, the processing unit 120 may be separated into numerous separate elements that may be shut down individually to conserve power. The separate elements may be related to specific functions. For example, an electronic communication function that controls Wi-Fi, Bluetooth, etc, may be a separate physical element that may be turned off to conserve power when electronic communication is not necessary. Each physical elements may be physically configured according to the specification and claims described herein.

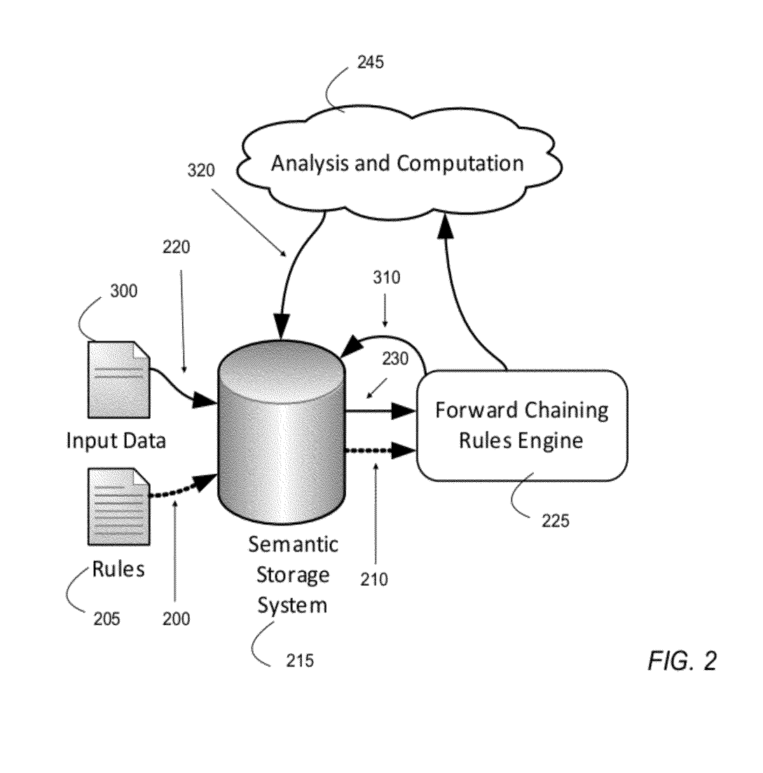

FIG. 2 may illustrate a method of using a forward chaining application on a computing device to monitor input data 300 such as scientifically related data in a semantic storage system 215 and to store provenance data 310 related to the input data 300 in the semantic storage system 215. A graph is “semantic” if the meaning of the graph is defined and exposed in an open and machine-understandable fashion. In other words, a graph is semantic if the semantics of the graph are part of the graph or at least connected from the graph. In this particular implementation, data is stored as nodes in a directed graph where the named edges (predicates) between nodes represent relationships in the data.

The input data 300 may be any data. The necessity and benefit of the method/system/apparatus may be best understood through discussing input data 300 such as scientific data or medical data, but as will become readily apparent, the method/system/apparatus may be useful in a variety of contexts and applications.

Rules 205 may be inserted into the semantic storage system 215 as indicated by the dotted arrow 200. The forward chaining mechanism 225 may then load the rules (as indicated by dotted arrow 210) from the semantic storage system 215. In general, an inference engine using forward chaining 225 searches the inference rules 205 until it finds a rule 205 where the antecedent (If clause) is known to be true. When found, the inference engine may conclude, or infer, the consequent (Then clause), resulting in the addition of new information to its data. Inference engines may iterate through this process until a goal is reached, specifically that there are no more rules 205 whose antecedent is satisfied given the current state of data in the semantic storage system 215.

In the method/system/apparatus described herein, a rule 205 may specify an antecedent and a consequent, but the antecedent may be implemented as a query that when executed against the semantic storage system returns results, and the consequent may be the specific kind of analysis to invoke on the results. The analysis 245 has the opportunity to produce more data such as that the analysis 245 occurred, that may be added into the semantic storage system 215 as provenance data 320, which may then be queryable by rule antecedents, etc.

The input data 300 may be added to the semantic storage system 215 where the input data 300 is noticed by the monitoring forward chaining mechanism 225. The forward chaining mechanism 225 may invoke the inference rules 205 that are stored in the semantic storage system 215 which may, for example, begin an analysis 245 of the newly added input data 300. Of course, the input data 300 may be added to the system in a variety of ways.

In some embodiments, some portions of the input data 300 may be stored externally (such as in a distributed computing environment) and accessed through a network 173. In another embodiment, the input data 300 may be stored locally such as in a flat file, in a relational database, or in another other appropriate storage manner. In addition, the input data 300 may be first stored elsewhere and then accessed to be added to the semantic storage system 215. As long as there is something stored in the semantic storage system 215 such as a pointer to the external data in order for the forward chaining mechanism to notice the input data 300, the input data 300 may be stored elsewhere.

In the present situation, scientific data may exist and be added to the semantic storage system 215 as input data 300. If an inference rule antecedent is satisfied (such as input data 300 of a certain type being added to the semantic storage system 215), an analysis 245 may be undertaken on the scientific input data 300 as prescribed by one of the rules 205. That the particular analysis 245 has been invoked may be added to the semantic storage system 215. The time the analysis 245 began as well as information about the particular analysis 245 invoked may also be added as additional data in the semantic storage system 215. The output 320 or results of the analysis 245 along with the time at which the analysis 145 ended may also be added as additional data in the semantic storage system 215 when the analysis completes.

Anything that happens to the input data 300 may be added as another node in the semantic graph in the semantic storage system 215 and as these nodes are part of the graph, these nodes are subject to queries. Further, a person or application may be able to search the semantic graph in the semantic storage system 215 to determine whether a particular analysis 245 of this input data 300 has taken place in the past. In this way, the same analysis 245 may not have to be repeated as the analysis 245 has already occurred. In addition, the results of the analysis 245 may be available in the semantic storage system 215. As a result, a significant amount of time may be saved and efficiency gained by not repeating analysis 245 that have already occurred. In addition, analyses 245 in the future may be varied based on the earlier analysis 245.

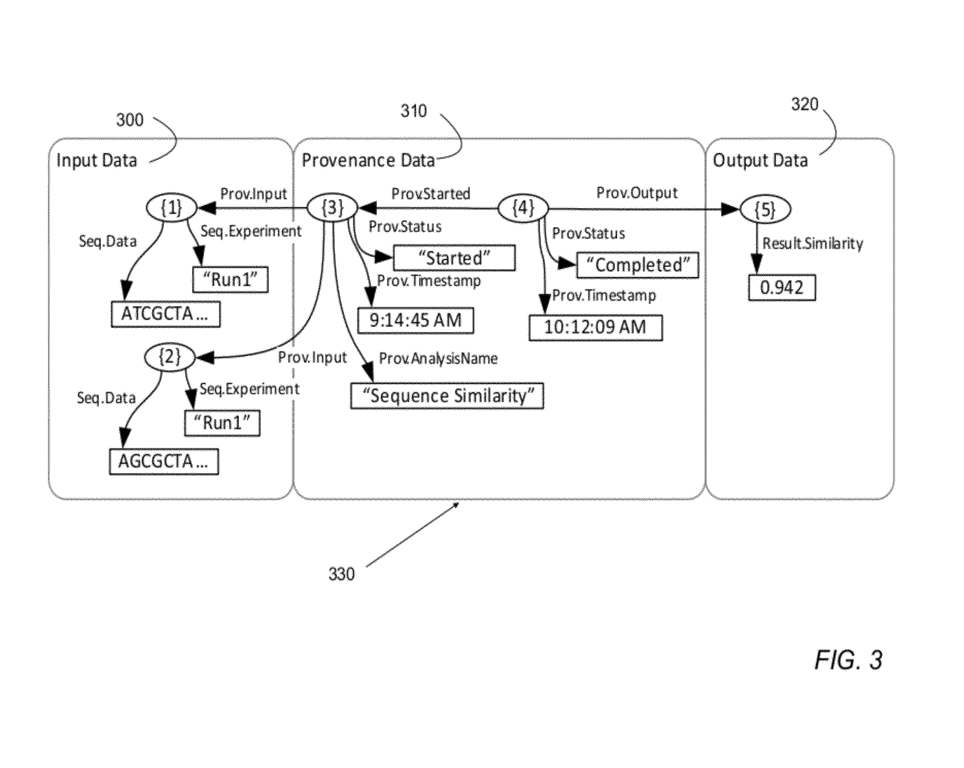

In FIG. 3, a semantic graph 330 is illustrated. The text “Seq.Data” is the name of the predicate (arrow) that points from the subject node to the object node. The subject and object nodes are data and the predicate (arrow) is the relationship between the data. In some embodiments, rules 205 may be added to the semantic storage system 215 to automatically perform analysis if input data 300 is added. A sample rule 205 may be that “Whenever two pieces of sequence data are persisted that have the same experiment name, initiate an analysis which computes the similarity percentage.” The rule 205 may be specified in a declarative format.

In other embodiments, the system may wait for a signal such as a user selecting that the rule 205 to be started or another application signaling that the analysis 245 should begin. This scenario may be achieved using the first scenario, such as an application that wishes to signal that an analysis 245 should begin may insert input data 300 in the semantic storage system 215 which is being watched by a rule 205 so that the act of requesting to run the analysis 245 is captured as data, leading to richer provenance data 310 stored in the semantic storage system 215.

A sample rule 205 may be “Whenever two pieces of sequence data (such as genetic sequences) are persisted that have the same experiment name, initiate an analysis which computes the similarity percentage”. The rule 205 may be specified in a declarative format. The forward chaining rules engine 225 may load 210 the declaration of this rule 205 and may begin the analysis 245, waiting for new input data 300 to be added to the semantic storage system 215.

As mentioned previously, provenance data 310 may also be added to the semantic storage system 215. At a high level, provenance data 310 may be data about the source of the input data 300 (who) and information about the analysis 245 of the input data 300. As an example, the provenance data 310 may include a start time of an analysis operation 245 and an end time of the analysis operation 245. As yet another example, the provenance data 310 may include timing data of when analysis on the data 300 occurred including how long it lasted and the computer analyses 245 that were performed on the input data 300.

The provenance data 310 may also include information of the results of the computer analysis 245 operations on the input data 300. For example, the computer operations may accept input data 300, perform computationally-intensive analysis 245, and produce output data 320 which may be stored back to the semantic storage system 215. In particular, the provenance data 310 may be used to link the output results 320 to the input data 300. The provenance data 310 may provide data that may be used in queries to trace a particular piece of output data 320 back to the input data 300 that produced it as well as the particular analysis 245 that was used to produce it. The results (output) 320 can then be queried in the future. Not only this, but the input data 300, provenance data 310 and output results 320 can be queried individually or together since they are all just data in the semantic graph

Moreover, the provenance data 310 may further include information about the previous analyses 245 that have manipulated the input data 300. In yet another embodiment, the computer operations that access or are applied to the input data 300 are stored as provenance data 310 as nodes in the semantic graph. In some embodiments, queries to the provenance data 310 may also be saved as provenance data 310 as the provenance data 310 is yet another node in the semantic storage system 215.

In one embodiment, the provenance data 310 is stored as one or more nodes in the semantic graph 215 with labeled edges between the nodes. By storing the provenance data 310 alongside the electronic input data 300, the provenance data 310 may be query-able. Further, as the provenance data 310 is stored with the input data 300, it will not be lost, misplaced, be subject to sporadic updates, etc., and will be readily accessible, even searchable.

The queries may be any query appropriate for the data stored in the semantic storage system 215, of which 300 310 and 320 are all a part. As mentioned earlier, the provenance data 310 may be virtually any data related to the input data 300 so the amount of information that may be queried is limited only by the extent of the provenance data 310 that is collected and stored.

Further, in some embodiments, the provenance data 310 may be queried to determine if the operations are operating properly. For example, if an invoked analysis 245 takes significantly more or less time than expected, it may mean there is a problem with the analysis 245, the input data 300, or both.

When rules stored in the semantic storage system 215 invoke an analysis operation 245 with input data 300, it may write provenance data 310 about the invocation to the semantic storage system 215. Furthermore, when the analysis 245 completes, it may write output data 320 to the semantic storage system 215. In addition provenance data 310 may be created by storing the time the analysis 245 completed in the semantic storage system 215. Queries for provenance data 310 may be used to determine if the analysis 245 completed correctly or, for example, what the average completion time for a particular analysis would be based on previous runs, etc.

FIG. 2 illustrates one example of the structure involved in the method/system/apparatus of the claims of using a forward chaining application 225 on a computing device 110 to monitor the semantic storage system 215 for input data 300 and to store provenance data 310 related to the scientific related data input data 300 in the semantic storage system 215.

As an example and not limitation, input data 300, in this case, two DNA sequences may be added to the semantic storage system 215. The forward chaining rules engine 225 may sense the input data 300 and the two DNA sequences may be extracted from the semantic storage system 215. Provenance data 310 may be written to the semantic storage system 215 that the new input data 300 has been loaded 230 for an analysis activity 245, for example. In this way, there will be a record of the analysis activity 245 invoked on the input DNA data 300 and when the analysis began. The analysis activity 245 may be invoked by the forward chaining rules engine 235 on the input data 300. The analysis activity 245 may be any appropriate analysis activity such as comparing two DNA strands. When the analysis activity 245 is complete, the resulting output data 320, such as a rating of how similar the two DNA strands are, may be added to the semantic storage system 215 next to the input data 300. Further, provenance data 310 about the analysis 245 may be stored in the semantic storage system 215 (e.g., processor requestor, process start time, process end time, etc.). As a result, future users may be able to search the provenance data 310 as well as input data 300 and output data 320 to determine that the two DNA strands have already been compared by a known user and the results of the comparison may be immediately determined, thereby saving time, creating efficiency and generating new pathways of research.

FIG. 3 illustrates a sample semantic graph 330 of the data that illustrate the input data 300, the provenance data 310 and the output data 320. In the semantic storage system 215, a first sequence {1} and a second sequence {2} may be added as input data 300. The provenance data 310 points to both the input data 300 and the output data 320 in such a way that a path connecting the input data 300 and output data 320 may be reified. All the data 300, 310, 320 is strongly typed in a way that it may be easily identified and understood by the rest of the system in accordance with semantic data logic.

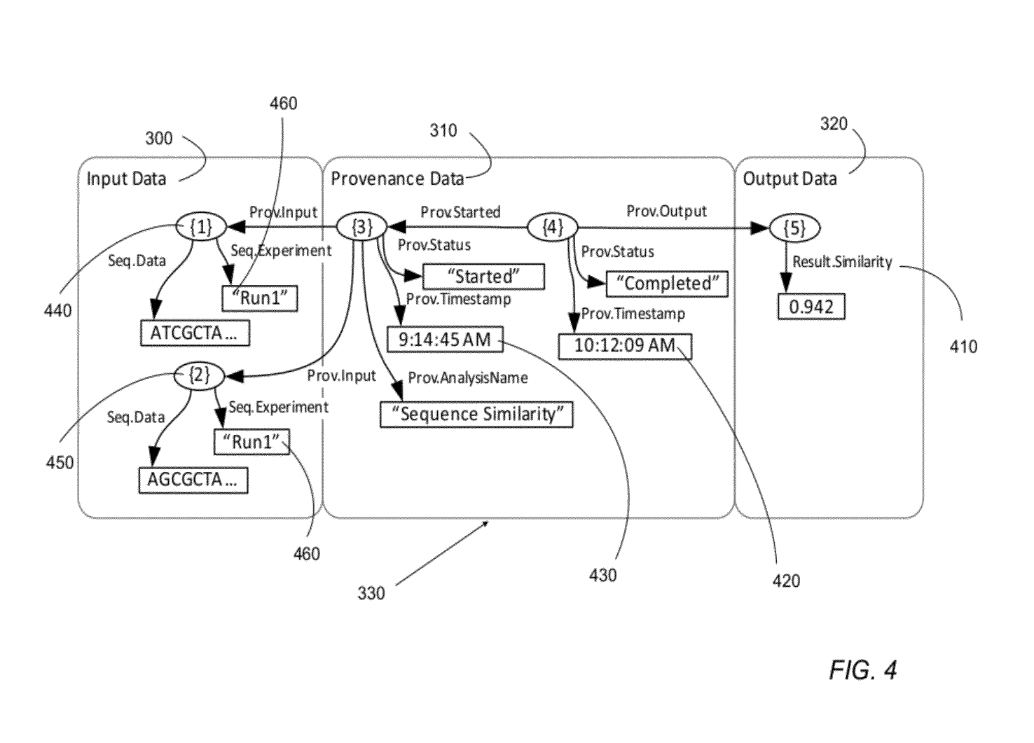

Referring to FIG. 4, as an example, a researcher may make a query whether two DNA sequences have a similarity score over 0.9. The query may look at the output data 320 and find a result similarity 410 of 0.942. The researcher may then wonder when such a comparison was made to determine if the results are new or old. The query may look at the various timestamps such as when the analysis 245 completed 420 in the provisional data 310. The researcher may then wonder whether the analysis 245 took a long time which may indicate that there was a problem with the analysis 245 such as the analysis 245 got stuck in an endless loop and was stopped prematurely. The query may then be of the start timestamp 430 which may be compared to the end timestamp 420 to determine that the run time was less than one hour which may seem acceptable to the researcher. The researcher may be further intrigued and may then review the input data 300 to see whether the desired sequence data 1 440 was compared to sequence data 2 450 (as opposed to another sequence data set) in the same run 460. Again, such data is available to be queried. Thus, the researcher has found that desired sequence 1 440 and sequence 2 450 have already been compared in a recent time frame in an acceptable manner in the same run 460 and that the similarity 410 was determined to be 0.942 meaning that the comparison does not have to be created again.

As a result of the method/system/apparatus, additional functionality may be possible that was not possible in the past. In the past, information about who analyzed data and when data was processed, whether the analysis 245 was successful or failed, what was the output 320, etc., may have been stored in hand written logs or in spreadsheets. Trying to search provenance data 310 required opening a separate application or searching by hand, assuming the provenance data 310 could even be located. By keeping the provenance data 310 with the underlying input data 300 and output data 320, the provenance data 310 will not be lost and will be searchable/queryable. By keeping the provenance data 310 with the input data 300 (and output data 320) and allowing it to be query-able, efficiencies and improvements will become possible.

As some examples, computer operations 245 that have occurred previously may be known and may not have to be repeated. Further, the result 320 of the analysis may be stored with the input data 300. In addition, the analysis 245 itself may be reviewed at the start time, end time and results of the analysis may be stored as provenance data 310 and may be studied to determine if the analysis is operating as desired. If the underlying input data becomes problematic such as it becomes erroneous, the chain of access to the input data 300, including, who, what and when, will likely be available and may be reviewed to determine what output data may also be erroneous.

In addition, capturing the provenance data 310 also opens up the possibility for automatic orchestration of analyses 245 using the data. Having the provenance data 310 beside the input data 300 also allows rules 205 to be specified which automatically orchestrate analysis. The rules 205 would be stored in the semantic storage system 215 and would automatically start if certain data appeared. As an example, if the provenance data 310 indicates that a particular analysis was completed successfully, the rule 205 may automatically invoke another analysis which re-computes and updates statistics about the average processing time of the analysis 245.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

1. A method of using a forward chaining application on a computing device to monitor a semantic storage system for scientific related data and to store provenance data related to the scientific related data in the semantic storage system comprising:
Receiving electronic scientific related data in the semantic storage system;
In the forward chaining application
Detecting that the scientific related data has been added;
Creating provenance data about the scientific related data wherein the provenance data comprises information about at least one selected from a group comprising:
a source of the scientific related data;
a time at which the scientific related data was received;
an invocation of analyses on the scientific related data;
completion of a successful analysis,
failure of an analysis, and
analysis information comprising information about a particular kind of analysis being invoked;
Storing the provenance data alongside the scientific related data in the semantic storage system; and
Allowing the provenance data to be queried.

2. The method of claim 1, wherein the scientific related data is stored in a semantic graph.

3. The method of claim 2, wherein the provenance data is stored as one or more nodes in the semantic graph with labeled edges between the nodes.

4. The method of claim 2, wherein the analysis further comprises a computer operation to be performed on the scientific related data.

5. The method of claim 4, wherein the analysis is stored as an addition to the provenance data as a node in the semantic graph.

6. The method of claim 5, wherein the provenance data is analyzed to determine if the computer operation is operating properly.

7. The method of claim 1, further comprising analyzing the provenance data, and if the provenance data satisfies a rule, automatically executing an additional analysis.

8. A computer system comprising a processor, a memory in communication with the processor and an input/output circuit, the processor being physically configured according to computer executable instructions for using a forward chaining application on a computing device to monitor a semantic storage system for scientific related data and to store provenance data related to the scientific related data in the semantic storage system, the computer executable instructions comprising instructions for:
Receiving scientific related data in the semantic storage system;
Storing the scientific related data in the semantic storage system
In the forward chaining application
Detecting that the scientific related data has been added to the semantic storage system;
Creating provenance data about the scientific related data wherein the provenance data comprises information about at least one selected from a group comprising:
a source of the scientific related data;
a time at which the scientific related data was received;
an invocation of analyses on the scientific related data;
completion of a successful analysis,
failure of an analysis, and
analysis information comprising information about a particular kind of analysis being invoked
Storing the provenance data alongside the scientific related data as one or more nodes in the semantic storage system with labeled edges between the nodes;
Allowing the provenance data to be queried.

9. The computer system of claim 8, wherein the analysis further comprises a computer operation to be performed on the scientific related data.

10. The computer system of claim 9, wherein the analysis is stored as an addition to the provenance data as a node in a semantic graph in the semantic storage system.

11. The computer system of claim 10, wherein the provenance data is analyzed to determine if the computer operation is operating properly.

12. The computer system of claim 8, further comprising analyzing the provenance data, and if the provenance data satisfies a rule, automatically executing an additional analysis.

13. A tangible computer storage medium physically configured to store computer executable instructions for using a forward chaining application on a computing device to monitor a semantic storage system for scientific related data and to store provenance data related to the scientific related data in the semantic storage system, the computer executable instructions comprising instructions for:
Storing the scientific related data in a semantic graph;
In the forward chaining application
Detecting that scientific data has been added to the semantic graph;
Creating provenance data about the scientific related data wherein the provenance data comprises information about at least one selected from a group comprising:
a source of the scientific related data;
a time at which the scientific related data was received;
an invocation of analyses on the scientific related data;
completion of a successful analysis,
failure of an analysis, and
analysis information comprising information about a particular kind of analysis being invoked
Storing the provenance data alongside the scientific related data as one or more nodes in the semantic graph with labeled edges between the nodes; and
Allowing the provenance data to be queried.

14. The tangible computer storage medium of claim 13, wherein the analysis further comprises a computer operation to be performed on the scientific related data.

15. The tangible computer storage medium of claim 14, wherein the analysis is stored as an addition to the provenance data as a node in a semantic graph in the semantic storage system.

16. The tangible computer storage medium of claim 15, wherein the provenance data is analyzed to determine if the computer operation is operating properly.

17. The tangible computer storage medium of claim 13, further comprising analyzing the provenance data, and if the provenance data satisfies a rule, automatically executing an additional analysis.
